(19) United States
(12) Patent Application Publication
(10) Pub. No.: US 2006/0104642 A1
(43) Pub. Date: May 18, 2006

(54) Directional antenna

(75) Inventors: Charles P. Capps, Carmel, IN (US); James L. Kohler, Kokomo, IN (US)

Correspondence Address: DELPHI TECHNOLOGIES, INC., M/C 480-410-202, PO BOX 5052, TROY, MI, 48007, US

(73) Assignee: Delphi Technologies, Inc.

(21) Appl. No.: 10/987,786

(22) Filed: Nov. 12, 2004

(51) Int. Cl. H04B 10/00

(52) U.S. Cl. 398/115

(57) ABSTRACT

A directional antenna is provided that transmits an information signal to a light source having a beam directing reflective surface. In an aspect, the information signal is impressed across a light filament and the reflective surface directs the electromagnetic radio waves in a predetermined direction. The radiated information signal may be used to detect an object or communicate with a receiver. The light source can be attached to a fixed structure or to mobile vehicle. In the case of a mobile vehicle, the antenna is fully concealed and can operate with an unmodified, factory installed vehicle headlight. In an aspect, material costs, manufacturing costs and assembly costs are reduced as compared to presently available antennas.

### FIELD OF THE INVENTION

The invention relates generally to wireless communications, and more particularly to a combined transmitter and receiver incorporating a light source having a beam directing reflective surface for use as a directional antenna.

### BACKGROUND OF THE INVENTION

In the past, telecommunication services integrated in an automobile were limited to a few systems, mainly analog radio reception (AM/FM bands), for which a simple whip antenna was mounted to and extended from a vehicle body. A disadvantage of this fixed mast monopole antenna is that it protrudes from the exterior of the vehicle as an unsightly vertical wire with a height of roughly one quarter wavelength of the signal frequency. This is because the whip antenna must exhibit certain mechanical characteristics to achieve user needs and meet required electrical performance. The antenna length, or the length of each element of an antenna array, depends on the received and transmitted signal frequencies. A further disadvantage of the monopole antenna is that it is susceptible to damage due to vandalism and car wash systems.

Further, the monopole antenna has a nearly omnidirectional radiation pattern, which provides a signal sent with approximately the same strength in all directions in a generally horizontal plane, producing a null only towards the sky. Another disadvantage of the monopole antenna is that it is typically narrowband with a bandwidth of roughly ten percent. With the rising number of communication systems, there are a continuously rising number of services that are to be integrated in the vehicle and which require further antennas to be arranged in the vehicle. Further, if antenna diversity is used to provide directional sensitivity, a number of antennas are required. However, since vehicle design is often dictated by styling, the presence of numerous protruding antennas is not desirable.

In an effort to minimize any aesthetically displeasing appearance or visually obstructive antenna characteristics, a trend emerged to embed the antenna system into the vehicle structure, such as, for example, into a rear window. Further, an integration of several telecommunication services into a single antenna is attractive to reduce manufacturing and installation costs of multiple antennas. However, rear window antennas exhibit troubles, for example pattern disconnection of the thin window antenna often occur.

Not only are the electrical, mechanical and aesthetic properties of an antenna important, but it must also overcome unique performance problems in the wireless environment. Further, antenna integration is becoming more necessary due to a cultural change towards an information society. The Internet has evoked an information age in which people around the globe expect, demand, and receive information. Car drivers expect to be able to drive safely while handling e-mail and telephone calls and obtaining directions, schedules, and other information accessible on the world wide web. Telematic devices can be used to automatically notify authorities of an accident and guide rescuers to the car, track stolen vehicles, provide navigation assistance to drivers, call emergency roadside assistance, and provide remote engine diagnostics. In designing the antenna, careful consideration must be given to the antenna electrical characteristics so that signals transmitted from and received by a communications device satisfies pre-determined operational limits, such as the bit error rate, signal-to-noise ratio or signal-to-noise-plus-interference ratio. In a number of applications, an omnidirectional antenna is less effective in achieving optimum values for these characteristics, as compared with a directional antenna.

The directional antenna, another form of antenna, provides a concentrated signal or beam in a selected direction. Concentrating the beam increases the antenna gain and directivity. Directional antennas are often utilized to communicate with terrestrial support, with short range communication systems (SRC). Radio frequency (RF) communication signals are typically employed for their advantages of penetrating and passing through objects, their low power, and their low cost.

However, directional antennas currently suffer from disadvantages of having complex shapes and large size, making them difficult to package in a vehicle. It is preferable to conceal the antenna to protect it from the environment and to preserve vehicle aesthetics. In order to conceal the antenna, it is usually necessary to locate the antenna beneath the sheet metal body of a vehicle. However, the sheet metal shields and adversely affects the performance of the directional antenna.

### SUMMARY OF THE INVENTION

A directional antenna is provided that utilizes an existing light having a beam directing reflective surface for transmitting electromagnetic radio waves. In view of the fact that lights having reflective surfaces are utilized in a wide variety of environments, it is to be appreciated that the present invention has numerous applications, including being employed with lights situated to a fixed structure such as to a building or post, as well as with lights attached to a mobile vehicle such as front headlights and rear lights.

In an embodiment, the directional antenna of the present invention reduces material costs, manufacturing costs and assembly costs, as compared to presently available antennas. The antenna system can be readily installed into a vehicle, may be operated without an impact on the performance of an existing headlight, and is fully concealed. Further, superior directivity of transmitting broadcasting signals is obtained at particular frequencies, as well as a reduction in power usage.

In an embodiment, the present invention can be used for vehicle-to-base or vehicle-to-vehicle communication systems. The present invention can be used for short range communication systems for a motor vehicle including electronic toll collection (ETC) systems. The present invention may further be useful for inter-roadway communication systems. The present invention can be used for long range communication systems. The present invention can further be useful for vehicle entry and exit monitoring systems, security and warning systems, adaptive cruise control, guidance applications, such as for controlling vehicles from drifting from their traffic lane. Additionally, the present invention may be used to detect objects, such as obstructions and other vehicles, distant from a vehicle in the forward direction. The present invention can be used for a forewarn ACC system or backup aid systems as well.

Features of the invention are achieved in part by making use of an existing light as the radiating antenna element. Together, the light filament and the light beam reflector direct the RF transmission toward an intended receiver. In an embodiment, the directional antenna system includes an alternating current (AC) source, and an illuminator having a reflective surface for directing a beam of light. The AC source provides AC via a transmission link to the illuminator for creating a magnetic field about the illuminator and radiating electromagnetic radio waves. The reflective surface directs the electromagnetic radio waves in a predetermined direction, maximizing antenna performance. In an embodiment, the illuminator is a filament incorporated into a vehicle headlight wherein a direct current (DC) source supplies current to the filament. The antenna system may be incorporated with a fixed structure or with a mobile vehicle including a car, truck, airplane, ship, boat, etc.

In an embodiment the present invention generates an RF signal having a bandwidth at a frequency in the range of about 1 megahertz (MHz) to at least 100 gigahertz (GHz) for broadcasting to a receiver or for detecting objects. Experimental results have shown the more useful transmitter frequencies, having acceptable gain and reaching a resonant frequency, are in the range of 80 MHz to 600 MHz for a standard motor vehicle headlight. It is to be appreciated that other standard motor vehicle headlights may vary in useful transmitter frequencies.

Other features and advantages of this invention will be apparent to a person of skill in the art who studies the invention disclosure. Therefore, the scope of the invention will be better understood by reference to an example of an embodiment, given with respect to the following figures.

### BRIEF DESCRIPTION OF THE DRAWINGS

The foregoing aspects and many of the attendant advantages of this invention will become more readily appreciated by reference to the following detailed description, when taken in conjunction with the accompanying drawings, wherein:

FIG. 1 is a perspective view of a conventional light and power connection as used in a motor vehicle, in which the present invention can be useful;

FIG. 2 is a diagrammatic sectional view illustrating the general components of an embodiment of the present invention;

FIG. 3 is a schematic view of the light as in FIG. 1 incorporating an embodiment of the present invention;

FIG. 4 illustrates a schematic view of directional beams transmitted from a filament and reflective surface, in an embodiment of the present invention;

FIG. 5 is a perspective view of an automobile showing a choice of motor vehicle lights that can act as a directive antenna, in which the present invention is useful, in an embodiment of the present invention;

FIG. 6 is a graphical illustration showing the resulting signal amplitude of a useful frequency impressed across a conventional light filament, in an embodiment of the present invention;

FIG. 7 is a two-dimensional side view of antenna pattern lobes being transmitted from a light filament, in an embodiment of the present invention; and

FIG. 8 is a graphical illustration of example measured RF beamwidth amplitudes measured having a transmission frequency of 6 GHz, in an embodiment of the present invention.

### DETAILED DESCRIPTION OF THE INVENTION

Exemplary embodiments are described with reference to specific configurations. Those of ordinary skill in the art will appreciate that various changes and modifications can be made while remaining within the scope of the appended claims. Additionally, well-known elements, devices, components, methods, process steps and the like may not be set forth in detail in order to avoid obscuring the invention. Further, unless indicated to the contrary, the numerical values set forth in the following specification and claims are approximations that may vary depending upon the desired antenna characteristics sought to be obtained by the present invention.

A system and method is described herein for providing a directional antenna by transmitting an information signal to a light source having a beam directing reflective surface. It is to be appreciated that features of the discussion and claims may be utilized with a simple light, which may be situated to a fixed structure such as to a building or post, as well as with lights attached to a mobile vehicle including a car, truck, bicycle, airplane, ship, and boat. The present invention may be used to detect an object or communicate with a receiver/transmitter. In an embodiment, the present invention is employed for communication services of a motor vehicle.

In an embodiment, the directional antenna provided by the present invention is readily installed into a vehicle. Material costs, manufacturing costs and assembly costs are reduced as compared with existing antennas. Further, an important advantage of the present invention is that the antenna system provided can be utilized with an assortment of vehicles and lights having distinct designs and manufacturers. Modification to an existing headlight is unnecessary for an extensive number of communication uses. Further, in an embodiment the present invention may be operated without any impact on the performance of the existing headlight, for example headlight luminosity or beam direction. The present invention also makes possible the elimination of mounting operations in production lines, such as the perforation of the car bodywork, together with the suppression of additional mechanical pieces that ensure a solid and watertight fixture of conventional whip antennas which are exposed to high air pressure. Additionally, the present invention cannot easily become disconnected (i.e., upon exterior vehicle cleaning). Moreover, the directional antenna provided is fully concealed and makes an imperceptible visual impact on the car design. Also, a driver's visibility (field of view) is not obstructed by the antenna system provided.

Additionally, a reduction in power is realized since the antenna beam patterns extend outward in the direction of the receiver and are attenuated in other directions. Superior directivity of transmitting broadcasting signals is also obtained. Further, by directing transmissions toward the receiver, and directively receiving signals, the antenna system of the present invention reduces effects of multipath fading. Further, the present invention obviates the problem of radiation leakage into the interior of a vehicle. Moreover, aerodynamic properties, a concern in regard to vehicle fuel consumption, are unaffected.

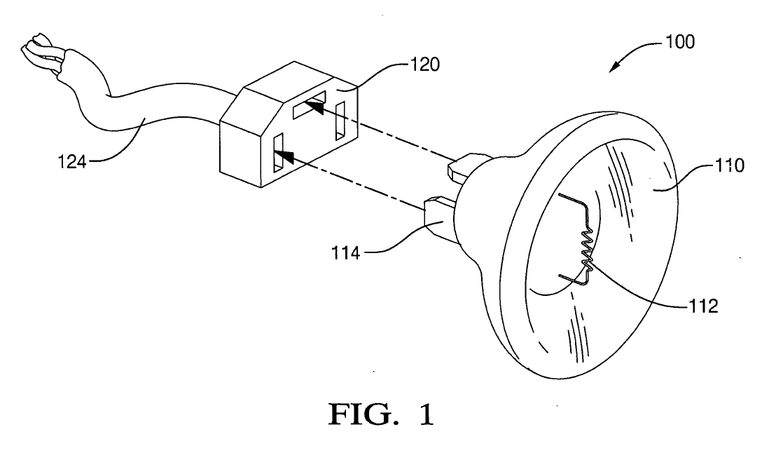

Referring to the drawings wherein identical reference numerals denote the same elements throughout the various views, FIG. 1 illustrates a conventional light and power connection as used in a motor vehicle, in which the present invention can be useful. Headlight 100 includes a filament 112 reflective surface 110 and male power connector 114. Headlight 100 reflects light by use of a reflective surface 110 formed in a parabolic shape, effecting a directive beam pattern. Typically, a direct current (DC) source such as a battery supplies operational power to the filament of headlight 100 via transmission cable 124. Transmission cable 124, conventionally a coaxial cable, provides power to, and is affixed to, female power connector 120. Other transmission lines can be utilized such as parallel-wire or waveguides for transmission of microwaves. Male power connector 114 connects to female power connector 120, transferring power to filament 112.

In an embodiment, the present invention applies an information signal to transmission cable 124, which is in the form of an alternating current (AC). Thus, transmission cable 124 provides both a DC power interface and an RF interface. The AC information signal flows to filament 112 with the usual DC power. A magnetic field is then produced around at least a portion of filament 112, which radiates energy in the form of electromagnetic waves to produce a wireless transmission. As discussed below, reflective surface 110 directs the electromagnetic waves in the direction that light beams are directed from reflective surface 110, without affecting the intensity or direction of any light beams generated from headlight 100. Reflective surface 110 can be in the shape of a parabola and direct electromagnetic waves as a parabolic antenna. Other shapes can also be used for reflective surface 110 including a hyperboloidal surface, ellipsoidal surface, etc.

In an embodiment of the present invention, a standard vehicle headlight acting as the radiating antenna element can be readily replaced for any reason (i.e., damaged headlight, worn filament, etc.) and the invention will fully operate. For example, headlight 100 can be disconnected from female power connector 120 and a replacement headlight reconnected to female power connector 120. An AC information signal generator is unaffected by such a replacement.

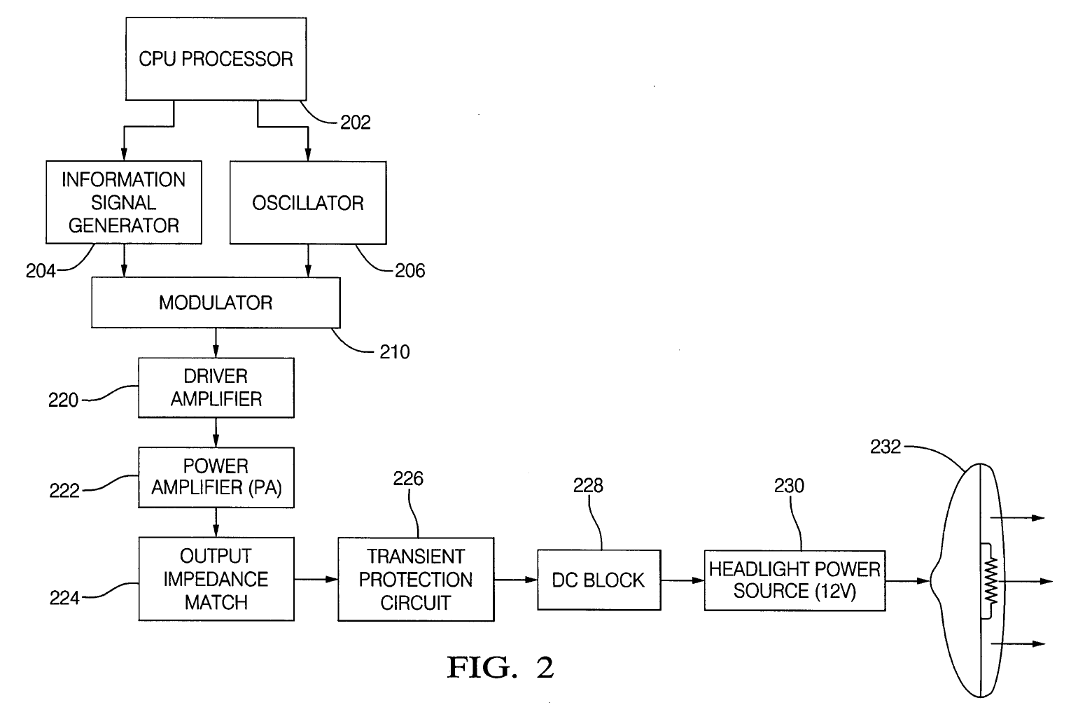

FIG. 2 is a diagrammatic sectional view illustrating the general components of an embodiment of the present invention. A processor 202 instructs information signal generator 204 to generate a desired information signal and feed it to modulator 210. In communications technology, it is of utmost importance to maximize antenna performance, including characteristics such as antenna gain, bandwidth, directivity and efficiency, and processor 202 is employed for that purpose. Frequency or signal interference may occur during transmission due to various conditions including weather, changes in terrain and other physical obstructions. To maintain signal and system integrity in the face of increasing error rates, a system operator or processor 202 can decrease the maximum data rate. Processor 202 also instructs oscillator 206 to generate a wave at the carrier frequency without harmonics or other spurious signal content. Oscillator 206 can generate either a fixed frequency or a variable frequency. Modulator 210 superimposes the information signal onto the carrier frequency. Driver amplifier 220 raises the signal power level to drive the final amplifier. There may be one or more driver stages depending upon the power needed to be delivered to the power amplifier (PA) 222. Driver amplifier 220 can also provide buffering and filtering operations. Power amplifier 222 delivers the required power to the transmitting headlight antenna 232. A signal generator, oscillator, modulator, driver amplifier and power amplifier electronics module are well known to one of ordinary skill in the art and, hence, will not be discussed in detail. Output impedance match 224 is provided to match the antenna impedance, transmission line impedance and transmitter impedance, and maximize power transfer from the antenna to a receiver. Transient protection circuit 226 protects at least items 202, 204, 206, 210, 220, 22 and 224 from large voltages/currents such as those that can occur during a load dump on power lines. DC block 228 effectively isolates DC current, generated by headlight power source 230, from reaching signal generator 204 to provide better gain and electromagnetic interference (EMI) immunity. Various DC blocks can be employed including a capacitor, transformer, optical coupler or other DC block. Once the AC information signal reaches headlight antenna 232, a magnetic field is produced and electromagnetic waves are directed to a receiver. The electromagnetic waves are directed to a receiver as discussed in FIG. 4 below.

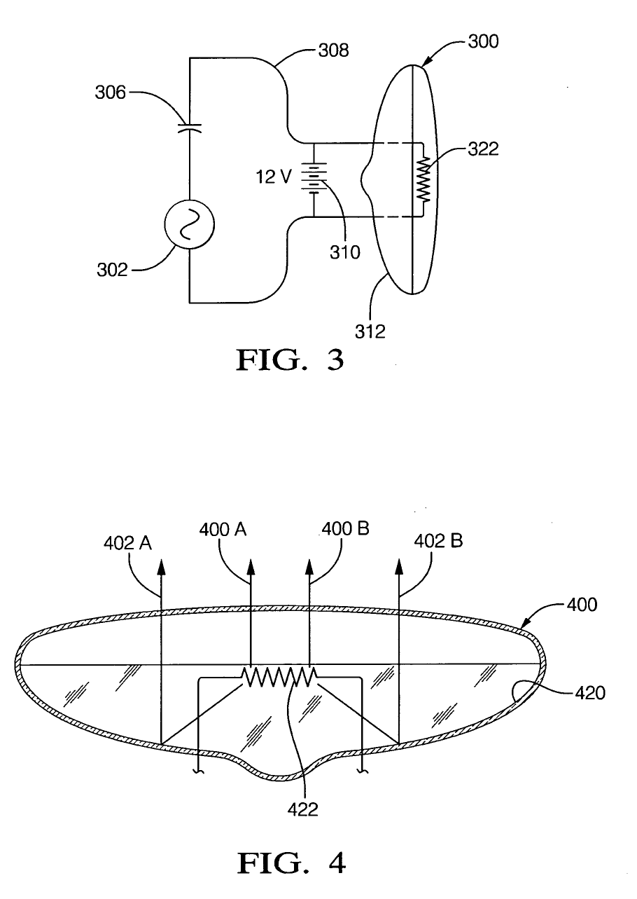

Referring to FIG. 3, a schematic view of the light 300, having a reflective surface 312, as in FIG. 1 is shown incorporating an embodiment of the present invention. AC signal generator 302 is connected in electrical series with DC block 306. A DC block is utilized to block DC current flowing from DC source 310 to AC signal generator 302. The DC block can include customary components such as a capacitor, transformer, optical coupler, diode, etc. AC signal generator 302 and DC block 306 are connected in electric parallel with DC source 310 and filament 322. Filament 322 receives supply power from DC source 310 for illuminating filament 322. The information signal generated from AC signal generator 302 is supplied to filament 322 via coaxial cable 308. Thus, an AC information signal and a DC voltage are fed to filament 322. Any noise can be minimized by system processing, for example in the case of a halogen headlight lamp.

FIG. 4 shows a schematic view of directional beams (modulated informational signal) transmitted from filament 422 and reflective surface 420, in an embodiment of the present invention. Headlight 400, having physical attributes for illumination use with a motor vehicle, is the type of headlight coming factory installed into a vehicle. The attributes of headlight 400 include a parabolic reflective surface 420 that emits light beams in a predetermined direction and distance. Electromagnetic waves 400a and 400b, and reflected electromagnetic wave 402a and 402b are directed alike customary light beams emitted from filament 422.

It is to be appreciated that modifications can be made to the physical attributes of reflective surface 420 or to filament 422 to change the directive beam pattern from the antenna array. For example, modifications can include adding an additional filament, changing the filament 422 size, length or shape, changing filament 422 spatial positioning in relation to reflective surface 420, and changing the curvature or shape of reflective surface 420. In the case wherein the length of filament 422 is decreased, the resonant frequency of the system is increased, since filament 422 length is inversely proportional to system resonant frequency. Causing an increase in resonant frequency may prove useful in certain broadcasting applications.

The system described follows established resonant frequency principles. In an embodiment, the transmitter is a variable frequency AC source. The variable frequency AC is applied to a series circuit containing some value of inductance and capacitance, which pose some value of reactance. As the frequency of the variable AC source is adjusted throughout its entire range, a specific frequency is reached causing the inductive reactance to equal the capacitive reactance. At this point in the frequency spectrum, the circuit current is the highest, capacitive reactance is equal to the inductive reactance, and resonant frequency is reached. As well known in the art, fᵣ=1/(2π√(LC)), where fᵣ is the resonant frequency, L is the inductance value and C is the capacitance value.

The range of the system transmission is dependant on the resonance selected and the selected power, which can be managed by the processor for the particular purpose of the transmission. In an embodiment, a transmission link is provided between a control means (not shown) and headlight antenna 232 (FIG. 2). Via the transmission link, the output of the antenna is transmitted to the control means, and power for operating a level adjusting means is transmitted from the control means to headlight antenna 232. For an extended transmission range, the headlight can be appropriately modified. Again, a headlight or vehicle manufacturer may decide to modify the headlight for alternative or improved performance of the antenna system.

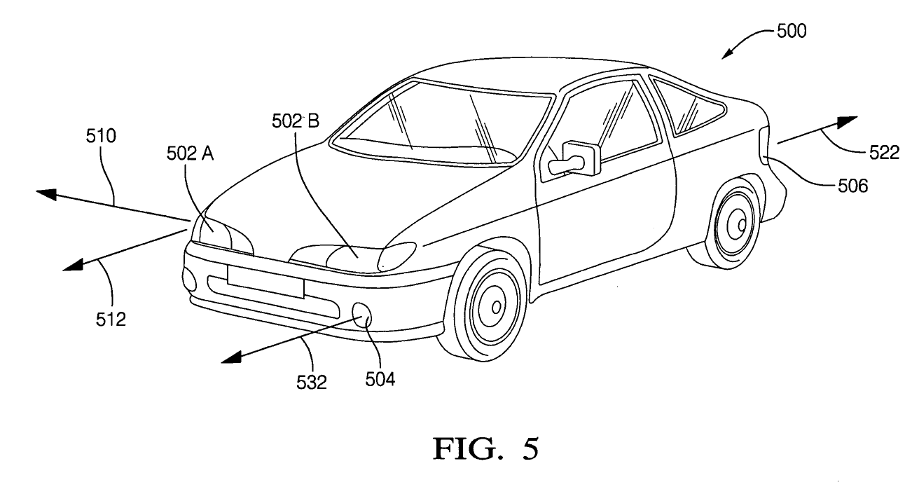

As illustrated in FIG. 5, a choice of motor vehicle lights can act as a directive antenna, including headlights 502A and 502B, fog lights 504, and brake lights 506. Lights that are mounted to a motor vehicle at other positions may similarly be utilized by an embodiment of the present invention. In an embodiment, a single headlight is employed for signal transmissions from motor vehicle 500. In another embodiment, additional headlights (two or more) are employed and processor 202 (FIG. 2) selects among the headlight antennas having various radiation patterns to maximize the received signal to noise, or signal to interference ratio. In a further embodiment, a phased array pattern is employed utilizing at least two vehicle headlights. In a phased array operation, the current magnitude and phase of each vehicle headlight is adjusted to reinforce the radiation pattern in a desired direction and suppress the radiation pattern in undesired directions.

Factory installed vehicle headlights often employ two separate filaments, one for a high intensity beam 510 and one for a low intensity beam 512. As illustrated in FIG. 5, the high intensity beam 510 directs the light beam at a higher vertical pitch, as compared with the low intensity beam 512. In an embodiment, the present invention employs the filament associated with the high intensity beam 510 as well as the filament associated with the low intensity beam 512. The filament associated with the high intensity beam 510 can be utilized for raising the vertical pitch of the directional antenna. This is useful to accommodate for signal interference due to an obstruction, or to accommodate for changes in orientation of the transmitter vehicle 500 relative to a receiver.

Vehicle headlights 502A and 502B, being spaced apart on a vehicle, maximize the distance between radiating antennas, in a phased array embodiment of the present invention. Hence, the relation between the direction and intensity of RF beam radiation of the antennas (directivity) can be improved by utilizing two vehicle headlights or a dual element antenna. Further, in regard to directional pattern or directivity, by utilizing two headlights set apart, the widths of the RF beams can be narrowed, and the directional resolution can be improved.

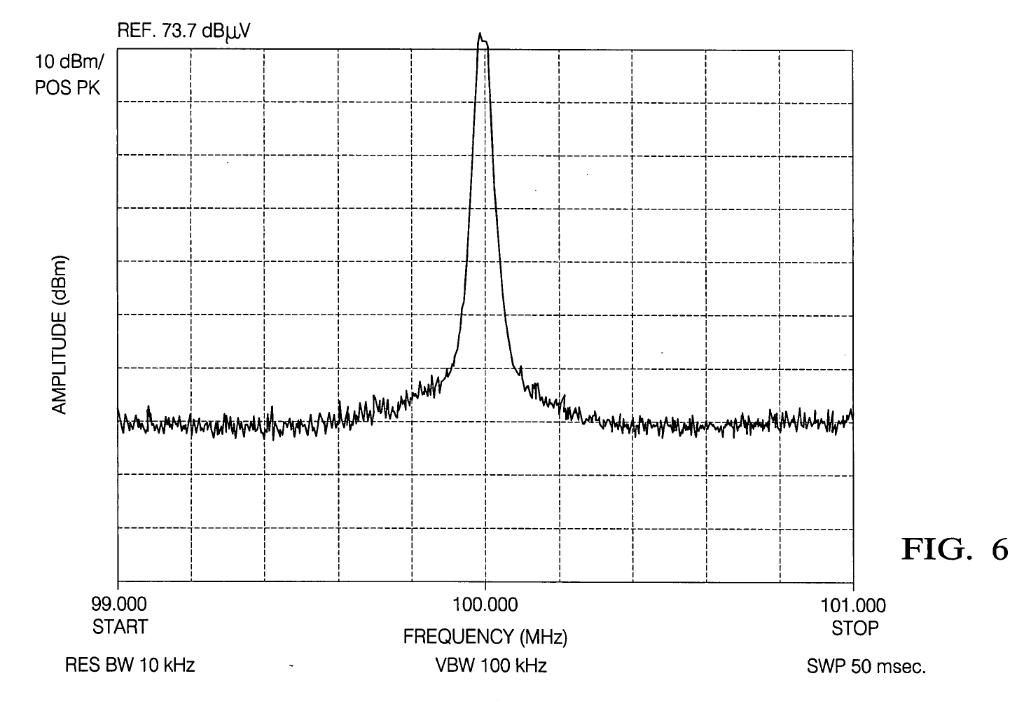

A further understanding of the above description can be obtained by reference to the following experimental result examples that are provided for illustrative purposes and are not intended to be limiting. As illustrated in FIG. 6, a frequency can be impressed across a conventional light filament, and a useful signal amplitude produced. FIG. 6 demonstrates the signal amplitude (dBm) produced by 100 MHz impressed across a conventional vehicle headlight filament. The spectral display illustrates the received signal showing frequency (MHz) on the horizontal axis and amplitude (dBm) on the vertical axis. In an embodiment, for short range communication applications, 100 MHz is an optimum frequency impressed across a conventional vehicle headlight filament. At 100 MHz, the bandwidth of the RF signal narrows since the antenna system is approaching its resonant frequency. Further, the antenna system shows improved dBm (decibels relative to 1 mW) amplitude near the resonant frequency.

In an embodiment, signal generator 204 (FIG. 2), generates a signal having a bandwidth at a frequency in the range of about 1 megahertz (MHz) to at least 100 gigahertz (GHz) for broadcasting to a receiver or for detecting objects. Experimental results have shown the more useful transmitter frequencies, having acceptable gain, are in the range of 80 MHz to 600 MHz for a standard motor vehicle headlight without any modifications to the headlight itself. It is to be appreciated that other standard motor vehicle headlights may vary in useful transmitter frequencies. Further, in an embodiment the present invention can transmit a range of frequency bands including a LF (low frequency), MF (medium frequency), HF (high frequency), VHF (very high frequency), UHF (ultra-high frequency), and satellite broadcasting.

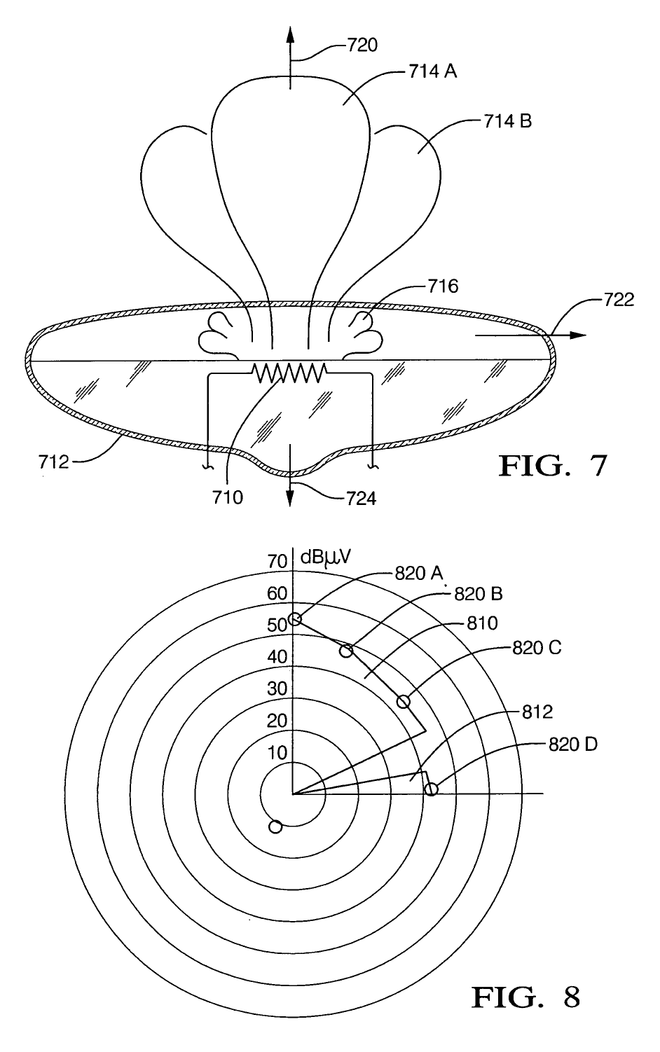

Referring to FIG. 7, an example two-dimensional view of antenna pattern lobes being transmitted from a directional antenna, such as light filament 422 (FIG. 4), is illustrated. The present invention utilizes such a directional pattern transmission to achieve improved/added gain radiated in a preferred direction over a signal radiated by an isotropic radiator. In an isotropic source, energy is radiated equally in all directions forming a sphere of radiation from the point source. By directing transmissions towards a receiver, the antenna of the present invention reduces any effects of interference. Further, since the antenna beam pattern lobes 714A and 714B extend outwardly in the general direction of the receiver (shown as direction 720, measured at 0 degrees), but are attenuated in most other directions (such as beam pattern lobes 716 in direction 722, measured at 90 degrees), less power is required. Moreover, reflector 712 redirects any beam patterns from direction 724 in a preferred direction such as direction 720 for added gain.

In an embodiment of the present invention, employing an unmodified vehicle headlight, experimental beamwidth amplitudes were recorded. The recorded example RF beamwidth amplitudes measured at 0 degrees, 30 degrees, 60 degrees and 90 degrees, having frequencies of 200 MHz, 1 GHz, 2 GHz, 4 GHz and 6 GHz are shown below in Table 1 below.

TABLE 1

| | | 0 degrees | 30 degrees | 60 degrees | 90 degrees |
|---|---|---|---|---|---|
| 200 | MHz | 76.7 | 76.5 | 74.5 | 74.8 |
| 1 | GHz | 58.7 | 54.5 | 51 | 54.2 |
| 2 | GHz | 61.9 | 59.9 | 55 | 44.5 |
| 4 | GHz | 58.4 | 39.9 | 44.6 | 48.4 |
| 6 | GHz | 54.2 | 47.2 | 44 | 42.5 |

FIG. 8 is a graphical illustration of example measured RF beamwidth amplitudes measured having a transmission frequency of 6 GHz. A single unmodified vehicle headlight was utilized as the radiating source. The beamwidth amplitude measurements of 54.2 dBμV, 47.2 dBμV, 44 dBμV and 42.5 dBμV (taken from Table 1 above), when plotted with measurement points connected, shows an outline of beam pattern lobes. One half of the beam pattern lobe 810 and a portion of lobe 812 can be observed. Point 820A corresponds to beamwidth amplitude 54.2 dBμV measured at 0 degrees, point 820B corresponds to beamwidth amplitude 47.2 dBμV measured at 30 degrees, point 820C corresponds to beamwidth amplitude 44 dBμV measured at 60 degrees, and point 820D corresponds to beamwidth amplitude 42.5 dBμV measured at 90 degrees.

It is to be appreciated that vehicle headlights are spaced with maximized distance, making the headlights a useful component for spacing needs of a phased array antenna system. In an embodiment of the present invention, separated vehicle headlights are employed as an antenna element and a phased array is electronically scanned or steered to a desired direction by controlling the phase angle of the signal input to each antenna element. Further, in an embodiment, increasing the separation of the two headlight antenna elements narrows the beamwidth. Moreover, in an embodiment, beamwidths are varied, for example to create a null to minimize interference between signal transmission and signal reception.

Other features and advantages of this invention will be apparent to a person of skill in the art who studies this disclosure. For example, it is to be appreciated that the antenna system as discussed herein may both transmit and receive signals through atmospheric free space. Thus, exemplary embodiments, modifications and variations may be made to the disclosed embodiments while remaining within the spirit and scope of the invention as defined by the appended claims.

We claim:

1. A directional antenna system comprising:
an alternating current (AC) source; and
an illuminator having a light beam directing reflective surface, wherein the AC source provides AC via a transmission link to the illuminator for creating a magnetic field about the illuminator and radiating electromagnetic radio waves, and wherein the reflective surface directs the electromagnetic radio waves in a predetermined direction.

2. The directional antenna system as in claim 1, wherein the illuminator is attached to one of a fixed structure and a mobile vehicle, wherein the fixed structure includes one of a building, fence and pole, and the mobile vehicle includes one of a car, truck, train, bicycle, airplane, and seagoing vessel.

3. The directional antenna system as in claim 1, wherein the illuminator is a filament incorporated into a vehicle light, and wherein the vehicle light is one of a headlight, fog light and brake light.

4. The directional antenna system as in claim 3, further comprising a direct current (DC) source for supplying current to the filament and a DC block for blocking DC from the AC source, wherein the filament and the DC source are connected in parallel with the AC source and a DC block, and wherein the AC source and the DC block are connected in series.

5. The directional antenna system as in claim 4, wherein the DC block is one of a capacitor, transformer, diode and an optical coupler, and wherein the transmission link is a coaxial cable.

6. The directional antenna system as in claim 1, further comprising a processor connected to the AC source and an oscillator, for instructing the AC source to generate a predetermined information signal and feed the information signal to a modulator, and for instructing the oscillator to generate a wave at a carrier frequency and feed the carrier frequency to the modulator, wherein the modulator superimposes the information signal onto the carrier frequency for transmission to the illuminator via the transmission link.

7. The directional antenna system as in claim 1, wherein the AC source generates an RF signal having a bandwidth at a frequency in the range of 1 megahertz (MHz) to 100 gigahertz (GHz) for broadcasting to a receiver and for detecting objects.

8. The directional antenna system as in claim 3, wherein the illuminator is modified from a standard manufactured version, wherein the modification including one of a modified filament size, modified filament length, modified filament shape, modified filament spatial positioning relative to the reflective surface, and an altered reflective surface shape.

9. The directional antenna system as in claim 1, further comprising a receiver, wherein the reflective surface receives radio frequency signals and transmits the radio frequency signals to the receiver.

10. A short range communication system comprising:
an illuminator having a light beam directing reflective surface
an information signal generator for generating a predetermined information signal and feeding the information signal to a modulator; and
an oscillator for generating a wave at a carrier frequency and feeding the carrier frequency to the modulator, wherein the modulator superimposes the predetermined information signal onto the carrier frequency for transmission to the illuminator via a transmission link.

11. The short range communication system as in claim 10, wherein the illuminator is a filament incorporated into a vehicle light, wherein the information signal and carrier frequency are impressed across the filament, and wherein the vehicle light is one of a headlight, fog light and brake light.

12. The short range communication system as in claim 10, wherein the information signal generator generates an RF signal having a bandwidth at a frequency in the range of 80 megahertz (MHz) to 600 megahertz (MHz) for broadcasting to a receiver and for detecting objects.

13. A method of forming a light source into a directional antenna comprising:
establishing an alternating current (AC) source; and
utilizing an illuminator having a light beam directing reflective surface, wherein the AC source provides AC via a transmission link to the illuminator to create a magnetic field about the illuminator to radiate electromagnetic radio waves, and wherein the reflective surface directs the electromagnetic radio waves in a predetermined direction.

14. The method as in claim 13, further comprising attaching the illuminator to one of a fixed structure and a mobile vehicle, wherein the fixed structure includes one of a building, fence and pole, and the mobile vehicle includes one of a car, truck, train, bicycle, airplane, and seagoing vessel.

15. The method as in claim 13, further comprising utilizing a filament incorporated into a vehicle light for the illuminator, wherein the vehicle light is one of a headlight, fog light and brake light.

16. The method as in claim 15, further comprising supplying current to the filament via a direct current (DC) source; blocking DC from the AC source utilizing a DC block; connecting the filament and the DC source in parallel with the AC source and the DC block; and connecting the AC source and the DC block in series.

17. The method as in claim 13, further comprising incorporating a processor connected to the AC source and an oscillator, to instruct the AC source to generate a predetermined information signal and feed the information signal to a modulator, and to instruct the oscillator to generate a wave at a carrier frequency and feed the carrier frequency to the modulator, wherein the modulator superimposes the information signal onto the carrier frequency for transmission to the illuminator via the transmission link.

18. The method as in claim 13, further comprising setting the AC source to generate an RF signal having a bandwidth at a frequency in the range of 1 megahertz (MHz) to 100 gigahertz (GHz) to broadcast to a receiver and to detect objects.

19. The method as in claim 15, further comprising modifying the illuminator from a standard manufactured version, wherein the modification including one of a modified filament size, modified filament length, modified filament shape, modified filament spatial positioning relative to the reflective surface, and an altered reflective surface shape.

20. The method as in claim 13, further comprising incorporating a receiver, wherein the reflective surface receives radio frequency signals and transmits the radio frequency signals to the receiver.
